(19) United States
(12) Patent Application Publication
(10) Pub. No.: US 2014/0139728 A1
(43) Pub. Date: May 22, 2014

(54) POWER SUPPLY DEVICE FOR CAMERA DEVICE IN A MOBILE TERMINAL

(71) Applicant: Samsung Electronics Co., Ltd., Gyeonggi-do (KR)

(72) Inventor: Soo-Hyung KIM, Gyeonggi-do (KR)

(73) Assignee: Samsung Electronics Co., Ltd., Gyeonggi-do (KR)

(21) Appl. No.: 14/079,938

(22) Filed: Nov. 14, 2013

(30) Foreign Application Priority Data
Nov. 16, 2012 (KR) 10-2012-0130401

(51) Int. Cl. H04N 5/232; H02M 3/04

(52) U.S. Cl. CPC H04N 5/23241; H02M 3/04
USPC 348/372; 323/234

(57) ABSTRACT

A power supply device for a camera device operating at a plurality of operating powers in a mobile terminal. A switching regulator generates an operating power having a highest power consumption among the operating powers from a battery power of the mobile terminal. The consumption current of the power supply device for the camera device can be significantly reduced by the switching regulator generating a sub power. The sub-power is supplied as a core power, a sensor power, and an Input/Output (I/O) power among the operating powers.

### CLAIM OF PRIORITY

This application claims priority under 35 U.S.C. §119(a) from a Korean Patent Application filed in the Korean Intellectual Property Office on Nov. 16, 2012 and assigned Serial No. 10-2012-0130401, the contents of which are incorporated herein by reference in its entirety.

### BACKGROUND

1. Technical Field

The present disclosure relates to a mobile device including a camera device. More particularly, the present invention relates to a power consumption and power that is supplied to a mobile terminal for to power a camera device.

2. Description of the Related Art

A variety of mobile terminals such as mobile phones, tablet PCs, notebooks, and smart phones are equipped with camera devices. More particularly, a mobile terminal usually includes a plurality of camera devices such as a front and rear cameras, which has recently become more popular than ever. In general, the front camera is installed on the front surface of the mobile terminal for use in capturing a forward scene from the mobile terminal. The rear camera is typically installed on the rear surface of the mobile terminal, for use in capturing a rear scene from the mobile terminal.

Referring now to FIG. 1 illustrating a typical example of disposition of a front camera in a mobile terminal, a front camera 102 is disposed at a top right-hand part of a display 104 on the front surface of a mobile terminal 100. It is also possible to dispose the front camera 102 at a position other than the top right-hand part on the front surface of the mobile terminal 100.

A necessary operating powers for the mobile terminal are generated from a battery by a power converter. A Low DropOut (LDO) and a switching regulator are usually used as the power converters for the mobile terminal. Different types of power converters differ in operational voltages, currents, and efficiency.

An LDO is a linear regulator that takes the difference between input and output voltages and burns it up as waste heat, thus operating to provide a voltage drop by reducing the input voltage by a predetermined difference. The efficiency of the LDO is calculated by dividing the output of the LDO voltage by the input voltage to the LDO. Accordingly, as the difference between the input voltage and the output voltage is wider, the LDO has a lower efficiency. A switching regulator converts an input DC power to an output power by storing energy in an inductor, while repeatedly regulating the input DC power through a switching device. The efficiency of the switching regulator is calculated by dividing the product between an output voltage and an output current by the product between an input voltage and an input current. In theory, the switching regulator has neither loss nor heat emission. Although if it is ideal, the switching regulator is 100% efficient, the switching regulator has an efficiency ranging from 80 to 90% in actual implementation.

An LDO is adopted as a power converter in a power supply device that generates an operating power from a battery, for the front camera of a mobile terminal. Typically, the front camera is used for self-shot or video call, and is sometimes referred to as a Video Telephony (VT) camera. However, as the usage of the front camera is confined to such limited situations as self-portrait or VT, the front camera generally does not consume much current from the power supply device of the camera device in the mobile device. Therefore, the utilization of an LDO as the power converter for generating an operating power for the front camera does not significantly affect the overall current consumption of the mobile terminal.

However, as a gesture recognition function has recently gained more importance in the mobile terminal, the front camera operates in a number of use modes of the mobile terminal than known heretofore. Especially even when the mobile terminal is placed in an idle mode, the front camera is used more frequently than ever before for gesture recognition. As a consequence, the power supply device for the front camera consumes more current in the mobile terminal than ever before due to the increased use of the front camera. Accordingly, there exists a need in the art for reducing the current consumption of the power supply device for a camera device such as a front camera.

### SUMMARY

An aspect of the present invention is to address at least some of the problems and/or disadvantages and to provide at least the advantages described below. Accordingly, an aspect of the present invention is to provide a power supply device for a camera device of a mobile terminal, which can reduce the amount of current consumed by the front camera device in a mobile terminal.

Another aspect of the present invention is to provide a power supply device for a camera device that optimizes the current consumption of the power supply device for the camera device in a mobile terminal.

In accordance with an exemplary embodiment of the present invention, there is provided a power supply device for a camera device that can output power at a plurality of operating powers in a mobile terminal, in which a switching regulator generates from a battery power of the mobile terminal an operating power value (level) having a highest power consumption from among the operating powers.

In accordance with another exemplary embodiment of the present invention, there is provided a power supply device for a camera device operating at a plurality of different operating powers in a mobile terminal, in which a switching regulator generates a sub-power from a battery power of the mobile terminal, a Low DropOut (LDO) generates a core power among the operating powers from the sub-power, and an LDO generates an Input/Output (I/O) power from among the operating powers from the sub-power. The sub-power is supplied as a sensor power from among the operating powers.

In accordance with still another exemplary embodiment of the present invention, there is provided a power supply device for a camera device operating at a plurality of operating powers in a mobile terminal, in which a switching regulator generates from a battery power of the mobile terminal a sub-power for output. The sub-power is supplied as one or more of a core power, a sensor power, and an I/O power from among the operating powers.

In accordance with yet another exemplary embodiment of the present invention, there is provided a power supply device for a camera device operating at a plurality of operating powers in a mobile terminal, in which a switching regulator generates a sub-power from a battery power of the mobile terminal, an LDO generates a core power among the operating powers from the sub-power, and an LDO generates from the battery power a sensor power among the operating powers. The sub-power is supplied as an I/O power among the operating powers.

In accordance with another exemplary embodiment of the present invention, there is provided a power supply device for a camera device operating at a plurality of operating powers in a mobile terminal, in which a switching regulator generates a sub-power from a battery power of the mobile terminal, and an LDO generates a sensor power among the operating powers from the battery power. The sub-power is supplied as a core power and an I/O power among the operating powers.

In accordance with another exemplary embodiment of the present invention, there is provided a power supply device for a camera device operating at a plurality of operating powers in a mobile terminal, in which a switching regulator generates from a battery power of the mobile terminal a core power among the operating powers, and a switching regulator generates a sub-power from the battery power. The sub-power is supplied as a sensor power and an I/O power from among the operating powers.

In accordance with a further exemplary embodiment of the present invention, there is provided a power supply device for a camera device operating at a plurality of operating powers in a mobile terminal, in which a switching regulator generates a core power from a battery power of the mobile terminal among the operating powers, a switching regulator generates a sub-power from the battery power, and an LDO generates an I/O power among the operating powers from the sub-power. The sub-power is supplied as a sensor power from among the operating powers.

### BRIEF DESCRIPTION OF THE DRAWINGS

The above and other exemplary objects, features and advantages of certain exemplary embodiments of the present invention will become more apparent from the following detailed description taken in conjunction with the accompanying drawings, in which:

FIG. 1 illustrates an exemplary illustration of a front camera in a typical mobile terminal;

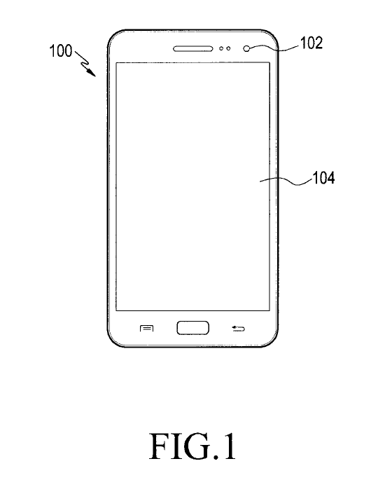

FIG. 2 is a block diagram of a mobile terminal according to a first exemplary embodiment of the present invention;

FIG. 3 is a block diagram of a mobile terminal according to a second exemplary embodiment of the present invention;

FIG. 4 is a block diagram of a mobile terminal according to a third exemplary embodiment of the present invention;

FIG. 5 is a block diagram of a mobile terminal according to a fourth exemplary embodiment of the present invention;

FIG. 6 is a block diagram of a mobile terminal according to a fifth exemplary embodiment of the present invention;

FIG. 7 is a block diagram of a mobile terminal according to a sixth exemplary embodiment of the present invention;

FIG. 8 is a block diagram of a mobile terminal according to a seventh exemplary embodiment of the present invention;

FIG. 9 is a block diagram of a mobile terminal according to an eighth exemplary embodiment of the present invention;

FIG. 10 is a block diagram of a mobile terminal according to a ninth exemplary embodiment of the present invention;

FIG. 11 is a block diagram of a mobile terminal according to a tenth exemplary embodiment of the present invention;

FIG. 12 is a block diagram of a mobile terminal according to an eleventh exemplary embodiment of the present invention;

FIG. 13 is a block diagram of a mobile terminal according to a twelfth exemplary embodiment of the present invention; and

FIG. 14 is an exemplary power sequence diagram of a front camera.

Throughout the drawings, the same drawing reference numerals will be understood to refer to the same elements, features and structures.

### DETAILED DESCRIPTION

Reference will now be made to exemplary embodiments of the present invention with reference to the attached drawings. The following description using reference numerals in the attached drawings is provided to assist a person of ordinary skill in the art with a comprehensive understanding of the embodiments of the present invention as defined by the claims and their equivalents. Like reference numerals denote the same components in the drawings.

While specific details are provided to help understanding of the exemplary embodiments of the present invention, they should be considered as being purely illustrative in nature, and do not limit the scope of the claimed invention to the examples shown and described herein. Therefore, those of ordinary skill in the art should understand and appreciation that that many variations and modifications can be made to the exemplary embodiments of the present invention described below that are within both the spirit and the scope of the presently claimed invention. In addition, a detailed description of a well-known functions and structures may be omitted from the written description so as not to obscure appreciation of the subject matter of the present invention by a person of ordinary skill in the art.

The terms and words used in the description and the claims are not limited to their literal meanings and used to enable clear and uniform understanding of the present invention by the present inventor. Therefore, their definitions should be made based on the entire specification.

The following description is given of exemplary embodiments of the present invention in the context of a power supply device for generating operating power for a front camera of a mobile terminal, by way of example. However, the exemplary embodiments of the present invention are applicable to other devices and fields. In addition, those skilled in the art can apply the principles of the present invention as embodied in the present claims to other devices with a slight modification made to them within the scope of the present invention. That is, the present invention can be implemented in a power supply device for a device other than a front camera in a mobile terminal.

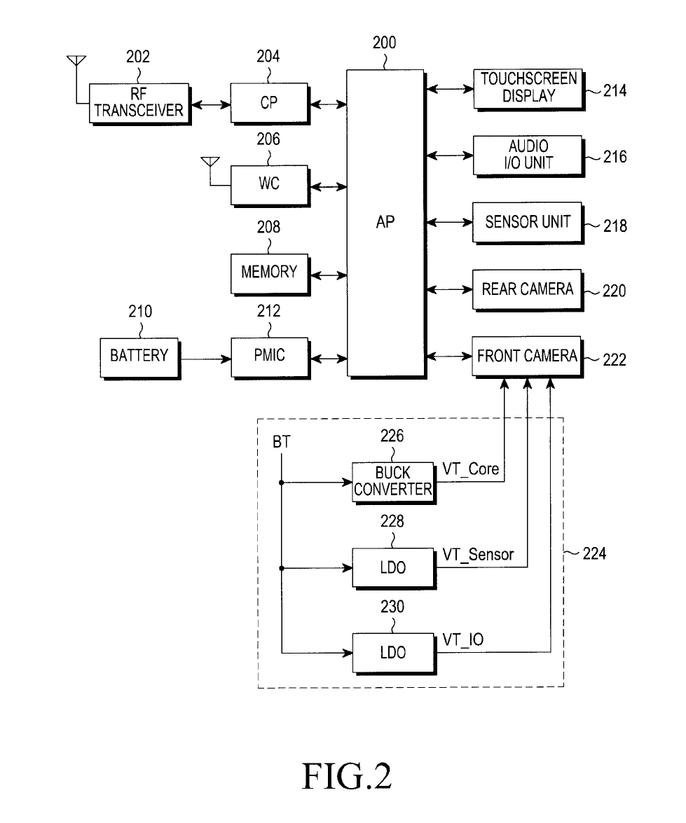

FIG. 2 is a block diagram of a mobile terminal according to a first exemplary embodiment of the present invention. Referring now to FIG. 2, the mobile terminal preferably includes a power supply device 224 according to this exemplary embodiment.

Still referring to FIG. 2, an Application Processor (AP) 200 is a main controller of the mobile terminal, which comprises hardware and controls and processes overall functions of the mobile terminal A Radio Frequency (RF) transceiver 202 converts an RF signal received from a mobile communication base station to a baseband signal and provides the baseband signal to a Communication Processor (CP) 204. The RF transceiver 202 also converts a baseband signal processed by the CP 204 to an RF signal and transmits the RF signal to the base station. The CP 204 takes charge of a number of processes for mobile communication. A Wireless Connectivity (WC) block 206 provides wireless communication functions such as Wireless Fidelity (Wi-Fi), BlueTooth (BT), and Near Field Communication (NFC).

A memory 208, which comprises a non-transitory machine readable medium, stores programs for operating the AP 200 and the CP 204 and data generated during operations of the AP 200 and the CP 204. The memory 208 may include an external memory and, in addition, a storage device such as a Hard Disk Drive (HDD). A Power Management Integrated Circuit (PMIC) 212 generates operating power needed for components of the mobile terminal from the battery power of a battery 210.

A touchscreen display 214 provides input and output interfaces between the mobile terminal and a user. The touchscreen display 214 displays a screen associated with an operation of the AP 200 and provides a touch screen input applied to the touch screen to the AP 200. Besides the touchscreen display 214, the mobile terminal may include another input device such as a keypad or buttons. The touchscreen may comprise LCD, LED, etc., and/or any type of thin-film technology (TFT). An audio Input/Output (I/O) unit 216 includes an audio output device like a speaker and an audio input device like a microphone and receives and outputs an audio signal according to an operating of the AP 200. A sensor unit 218 preferably includes one or more of a gyro sensor, an acceleration sensor, a proximity sensor, an ambient light sensor, a magnetic sensor, etc. A rear camera 220 is installed on the rear surface of the mobile terminal, for use in capturing a rear scene from the mobile terminal. A front camera 222 is installed on the front surface of the mobile terminal, for use in capturing a front scene from the mobile terminal.

The power supply device 224 generates operating power for the front camera 222. A camera device such as the front camera 222 requires a plurality of operating powers. These operating powers include a core power VT_Core, a sensor power VT_Sensor, and an I/O power VT_IO as illustrated in the example of FIG. 2. The core power VT_Core is used for a core processor (not shown) among operating components of the front camera 222. The core processor provides overall control to the operations of the front camera 222 and processes a captured image signal. The sensor power VT_Sensor is an operating power used for an image sensor (not shown) among the operating components of the front camera 222. The image sensor senses object information and converts the sensed object information to an electrical image signal. The I/O power VT_IO is an operating power used for an I/O unit (not shown) among the operating components of the front camera 222. The I/O unit provides data communication between the core processor of the front camera 222 and the AP 200.

The power supply device 224 in this example includes a buck converter 226 and Low DropOuts (LDOs) 228 and 230. The buck converter 226 is a type of switching regulator. In general, switching regulators are divided into a buck converter, a boost converter, a buck-boost converter, and an inverter. The buck converter, the boost converter, and the buck-boost converter will convert DC power from a first level to DC power of a second level different from the first level, whereas the inverter converts DC power to AC power. The buck converter is a step-down DC/DC converter that reduces an input power voltage at an output thereof. The boost converter is a step-up DC/DC converter that raises an input power voltage. The buck-boost converter is a step-down and step-up DC/DC converter that raises and drops an input power voltage.

The buck converter 226 generates the core power VT_Core from a battery power BT and supplies the core power VT_Core to the front camera 222. The LDO generates the sensor power VT_Sensor from the battery power BT and supplies the sensor power VT_Sensor to the front camera 222. The LDO 230 generates the I/O power VT_IO from the battery power BT and supplies the I/O power VT_IO to the front camera 222.

For example, assuming in this example that the voltages of the battery power BT, the core power VT_Core, the sensor power VT_Sensor, and the I/O power VT_IO are 3.8V, 1.5V, 2.8V, and 1.8V, respectively, the load-end consumption currents of the front camera 222, that is, the consumption currents of the core processor, the image sensor, and the I/O unit are 100 mA, 30 mA, and 5 mA, respectively, and the efficiency of the buck converter 226 is 90%, input-end consumption currents, that is, input-end consumption currents of the core power VT_Core, the sensor power VT_Sensor, and the I/O power VT_IO are given as illustrated in this example in Table 1. The load-end consumption currents refer to currents consumed in the core processor, the image sensor, and the I/O unit, respectively. The input-end consumption currents refer to currents applied to the front camera 222 from the battery power BT through the power supply device 224. In other words, the input-end consumption currents are currents applied to the buck converter 226 and the LDOs 228 and 230 in the illustrated case of FIG. 2. The terms load-end consumption current′ and ‘input-end consumption current’ are used in the same meanings as described above in exemplary embodiments of the present invention which are described later. An artisan should understand and appreciate that the claimed invention is not limited to operation in values shown in Table 1 or any of the other tables herein.

TABLE 1

| | Operation | Load-End | | |
|---|---|---|---|---|
| | Power | Consumption | Battery | Input-End |
| Operation | Voltage | Current | Power | Consumption |
| Power | [V] | [mA] | Voltage [V] | Current [mA] |
| VT_Core | 1.5 | 100 | 3.8 | 43.85 |
| VT_Sensor | 2.8 | 30 | | 30 |
| VT_IO | 1.8 | 5 | | 5 |

| | |
|---|---|
| Sum | 78.85 |

As noted from (Table 1), although the input-end consumption currents of the sensor power VT_Sensor and the I/O power VT_IO generated by the LDOs 228 and 230 are equal to their load-end consumption currents, in this example the input-end consumption current 43.85 mA of the core power VT_Core is less than its load-end consumption current. Since the efficiency of the switching regulator is expressed as a value calculated by dividing the product between an output voltage and an output current by the product between an input voltage and an input current, the input-end consumption current of the core power VT_Core is calculated by core power VT_Core voltage×load-end consumption current/battery power BT voltage/90% (=1.5V×100 mA/3.8V/0.9=43.85 mA).

If the core power VT_Core is generated by an LDO as is done conventionally, instead of the buck converter 226, the input-end consumption currents are given as follows in (Table 2).

TABLE 2

| | Operation | Load-End | | |
|---|---|---|---|---|
| | Power | Consumption | Battery | Input-End |
| Operation | Voltage | Current | Power | Consumption |
| Power | [V] | [mA] | Voltage [V] | Current [mA] |
| VT_Core | 1.5 | 100 | 3.8 | 100 |
| VT_Sensor | 2.8 | 30 | | 30 |
| VT_IO | 1.8 | 5 | | 5 |

| | |
|---|---|
| Sum | 135 |

A comparison between (Table 1) and (Table 2) reveals that the input-end consumption current of the core power VT_Core is much less when the core power VT_Core is generated by the buck converter 226 than when the core power VT_Core is generated by the LDO. Thus, in this example, the total input-end consumption current is remarkably reduced from 135 mA to 78.85 mA.

Among the operating powers of a camera device such as the front camera 222, a power consumption of the core power VT_Core is great, relative to the other operating powers. As illustrated in the non-limiting exemplary values in Table 1 and Table 2, the core power VT_Core has a large voltage difference from the battery power and has much current consumption. Consequently, the consumption current of the power supply device 224 is significantly reduced by generating the core power VT_Core using the buck converter 226 instead of the LDO.

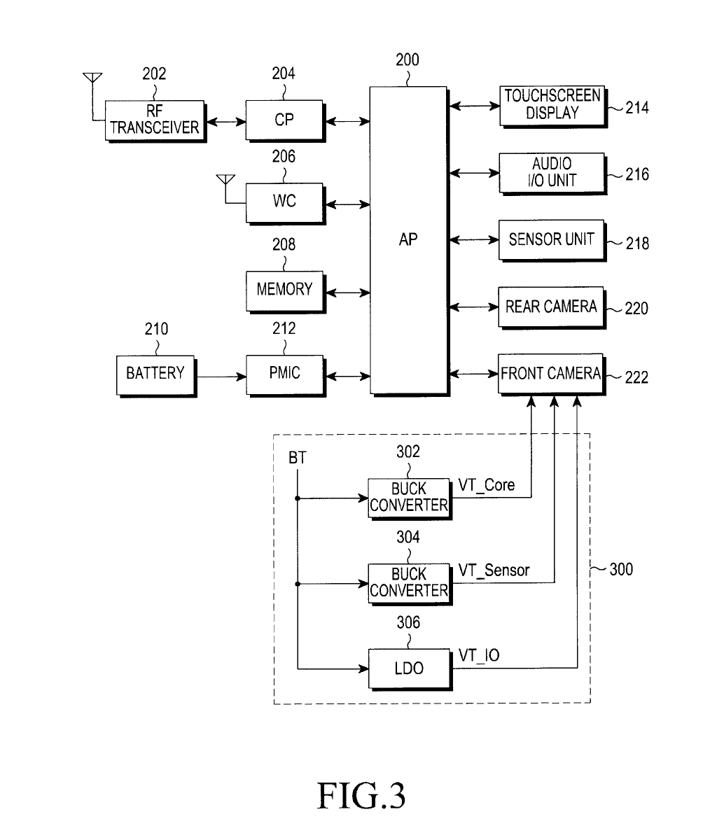

FIG. 3 is a block diagram of a mobile terminal according to a second exemplary embodiment of the present invention. The mobile terminal illustrated in FIG. 3 includes a power supply device 300 according to this particular example. The mobile terminal illustrated in FIG. 3 is the same as that illustrated in FIG. 2 except for the power supply device 300 and thus a description of the other components will not be provided herein again to avoid redundancy.

Referring now to FIG. 3, the power supply device 300 includes buck converters 302 and 304 and an LDO 306. The buck converter 302 generates the core power VT_Core from the battery power BT and supplies the core power VT_Core to the front camera 222. The buck converter 304 generates the sensor power VT_Sensor from the battery power BT and supplies the sensor power VT_Sensor to the front camera 222. The LDO 306 generates the I/O power VT_IO from the battery power BT and supplies the I/O power VT_IO to the front camera 222.

For example, assuming in this example that the voltages of the battery power BT, the core power VT_Core, the sensor power VT_Sensor, and the I/O power VT_IO are 3.8V, 1.5V, 2.8V, and 1.8V, respectively, the load-end consumption currents of the front camera 222, that is, the consumption currents of the core processor, the image sensor, and the I/O unit are 100 mA, 30 mA, and 5 mA, respectively, and the efficiency of the buck converters 302 and 304 is 90%, input-end consumption currents, that is, input-end consumption currents of the core power VT_Core, the sensor power VT_Sensor, and the I/O power VT_IO are given as illustrated in the non-limiting exemplary values shown in Table 3 herein below.

TABLE 3

| | Operation | | | |
|---|---|---|---|---|
| | Power | Load-End | Battery | Input-End |
| Operation | Voltage | Consumption | Power | Consumption |
| Power | [V] | Current [mA] | Voltage [V] | Current [mA] |
| VT_Core | 1.5 | 100 | 3.8 | 43.85 |
| VT_Sensor | 2.8 | 30 | | 24.56 |
| VT_IO | 1.8 | 5 | | 5 |

| | |
|---|---|
| Sum | 73.41 |

As noted from (Table 3), although the input-end and load-end consumption currents of the I/O power VT_IO generated by the LDO 306 are equal, the input-end consumption currents 43.85 mA and 24.56 mA of the core power VT_Core and the sensor power VT_Sensor are less than their load-end consumption currents. The input-end consumption current of the core power VT_Core is calculated as described before with reference to (Table 1) and the input-end consumption current of the sensor power VT_Sensor is also calculated in a similar manner by sensor power VT_Sensor voltage×load-end consumption current/battery power BT voltage/90%.

A comparison between Table 2 and Table 3 reveals that the total input-end consumption current is remarkably reduced from 135 mA to 73.41 mA, which is a value slightly more than half the value of Table 2.

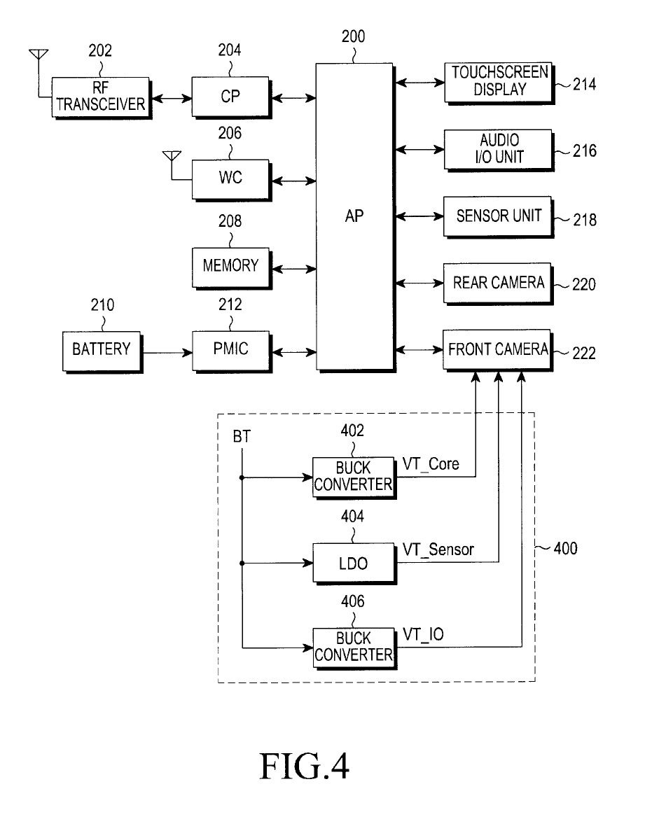

FIG. 4 is a block diagram of a mobile terminal according to a third exemplary embodiment of the present invention. The mobile terminal illustrated in FIG. 4 includes a power supply device 400 according to the third exemplary embodiment of the present invention. The mobile terminal illustrated in FIG. 4 is the same as that illustrated in FIG. 2 except for the power supply device 400 and thus a description of the other components will not be provided herein.

Referring now to FIG. 4, the power supply device 400 in this example includes buck converters 402, 406 and an LDO 404. The buck converter 402 generates the core power VT_Core from the battery power BT and supplies the core power VT_Core to the front camera 222. The LDO 404 generates the sensor power VT_Sensor from the battery power BT and supplies the sensor power VT_Sensor to the front camera 222. The buck converter 406 generates the I/O power VT_IO from the battery power BT and supplies the I/O power VT_IO to the front camera 222.

For example, assuming in this example that the voltages of the battery power BT, the core power VT_Core, the sensor power VT_Sensor, and the I/O power VT_IO are 3.8V, 1.5V, 2.8V, and 1.8V, respectively, the load-end consumption currents of the front camera 222, that is, the consumption currents of the core processor, the image sensor, and the I/O unit are 100 mA, 30 mA, and 5 mA, respectively, and the efficiency of the buck converters 402 and 406 is 90%, input-end consumption currents, that is, input-end consumption currents of the core power VT_Core, the sensor power VT_Sensor, and the I/O power VT_IO are given as illustrated in the examples shown in Table 4.

TABLE 4

| | Operation | | | |
|---|---|---|---|---|
| | Power | Load-End | Battery | Input-End |
| Operation | Voltage | Consumption | Power | Consumption |
| Power | [V] | Current [mA] | Voltage [V] | Current [mA] |
| VT_Core | 1.5 | 100 | 3.8 | 43.85 |
| VT_Sensor | 2.8 | 30 | | 30 |
| VT_IO | 1.8 | 5 | | 2.63 |

| | |
|---|---|
| Sum | 76.48 |

As noted from Table 4, although the input-end and load-end consumption currents of the sensor power VT_Sensor generated by the LDO 404 are equal, the input-end consumption currents 43.85 mA and 2.63 mA of the core power VT_Core and the I/O power VT_IO are less than their load-end consumption currents. The input-end consumption current of the core power VT_Core is calculated as described before with reference to Table 1 and the input-end consumption current of the I/O power VT_IO is also calculated in a similar manner by I/O power VT_IO voltage×load-end consumption current/battery power BT voltage/90%.

A comparison between Table 2 and Table 4 reveals that the total input-end consumption current is remarkably reduced from 135 mA to 76.48 mA.

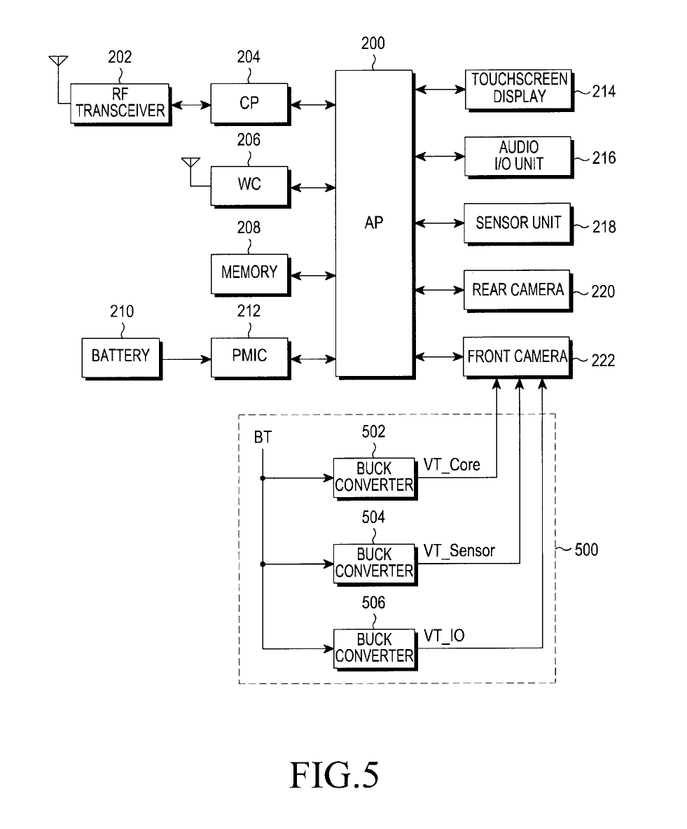

FIG. 5 is a block diagram of a mobile terminal according to a fourth exemplary embodiment of the present invention. The mobile terminal illustrated in the example shown in FIG. 5 includes a power supply device 500 according to the fourth exemplary embodiment. The mobile terminal illustrated in FIG. 5 is the same as that illustrated in FIG. 2 except for the power supply device 500 and thus a description of the other components will not be provided herein.

Referring now to FIG. 5, the power supply device 500 includes buck converters 502, 504 and 506. The buck converter 502 generates the core power VT_Core from the battery power BT and supplies the core power VT_Core to the front camera 222. The buck converter 504 generates the sensor power VT_Sensor from the battery power BT and supplies the sensor power VT_Sensor to the front camera 222. The buck converter 506 generates the I/O power VT_IO from the battery power BT and supplies the I/O power VT_IO to the front camera 222.

For example, assuming in this example that the voltages of the battery power BT, the core power VT_Core, the sensor power VT_Sensor, and the I/O power VT_IO are 3.8V, 1.5V, 2.8V, and 1.8V, respectively, the load-end consumption currents of the front camera 222, for example, the consumption currents of the core processor, the image sensor, and the I/O unit are 100 mA, 30 mA, and 5 mA, respectively, and the efficiency of the buck converters 502, 504 and 506 is 90%, input-end consumption currents, that is, input-end consumption currents of the core power VT_Core, the sensor power VT_Sensor, and the I/O power VT_IO are given as illustrated in the examples in Table 5.

TABLE 5

| | Operation | | | |
|---|---|---|---|---|
| | Power | Load-End | Battery | Input-End |
| Operation | Voltage | Consumption | Power | Consumption |
| Power | [V] | Current [mA] | Voltage [V] | Current [mA] |
| VT_Core | 1.5 | 100 | 3.8 | 43.85 |
| VT_Sensor | 2.8 | 30 | | 24.56 |
| VT_IO | 1.8 | 5 | | 2.63 |

| | |
|---|---|
| Sum | 71.04 |

As noted from Table 5, although the input-end consumption currents 43.85 mA, 24.56 mA, and 2.63 mA of the core power VT_Core, the sensor power VT_Sensor, and the I/O power VT_IO are less than their load-end consumption currents. The input-end consumption current of the core power VT_Core is calculated in the manner described before with reference to Table 1, the input-end consumption current of the sensor power VT_Sensor is calculated in the manner described with reference to with reference to Table 3, and the input-end consumption current of the I/O power VT_IO is calculated in the manner described with reference to Table 4.

A comparison between Table 2 and Table 5 reveals that the total input-end consumption current is remarkably reduced from 135 mA to 71.04 mA.

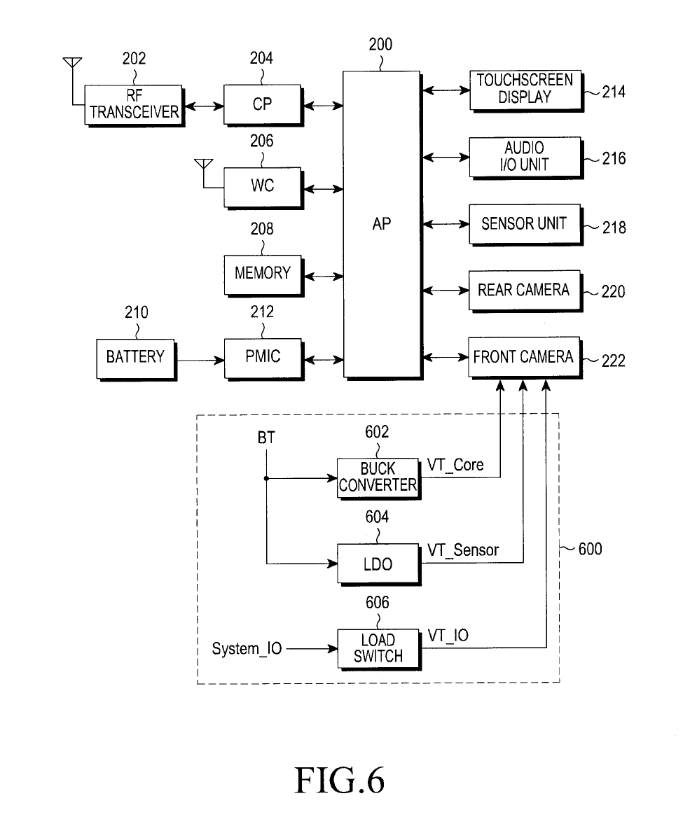

FIG. 6 is a block diagram of a mobile terminal according to a fifth embodiment of the present invention. The mobile terminal illustrated in FIG. 6 includes a power supply device 600 according to fifth exemplary embodiment of the present invention. The mobile terminal illustrated in FIG. 6 is the same as that illustrated in FIG. 2 except for the power supply device 600 and thus a description of the other components will not be provided herein.

Referring now to FIG. 6, the power supply device 600 includes a buck converter 602, an LDO 604, and a load switch 606. The buck converter 602 generates the core power VT_Core from the battery power BT and supplies the core power VT_Core to the front camera 222. The LDO 604 generates the sensor power VT_Sensor from the battery power BT and supplies the sensor power VT_Sensor to the front camera 222. The load switch 606 supplies a system I/O power System_IO as the I/O power VT_IO to the front camera 222. The system I/O power System_IO is an operating power commonly used for the input and output units of the mobile terminal, among the operating powers generated by the PMIC 212.

Since a camera device such as the front camera 222 is sensitive to noise, noise-sensitive operating powers such as the core power VT_Core and the sensor power VT_Sensor are independent powers. However, in the case of an operating power less sensitive to noise like the I/O power VT_IO, a common power such as the system I/O power System_IO is available as far as the operating power less sensitive to noise is the same in voltage and is not high in power consumption. Therefore, the power supply device 600 supplies the system I/O power System_IO as the I/O power VT_IO by the load switch 606, rather than the I/O power VT_IO is generated by an additional power supply device. In general, a load switch is a device that switches a power supply, that is, a device for turning-on or turning-off the power supply which is used when the power supply needs to be switched by external control.

For example, assuming in this example that the voltages of the battery power BT, the core power VT_Core, the sensor power VT_Sensor, and the I/O power VT_IO are 3.8V, 1.5V, 2.8V, and 1.8V, respectively, the load-end consumption currents of the front camera 222, for example, the consumption currents of the core processor, the image sensor, and the I/O unit are 100 mA, 30 mA, and 5 mA, respectively, and the efficiency of the buck converter 602 is 90%, input-end consumption currents, that is, input-end consumption currents of the core power VT_Core, the sensor power VT_Sensor, and the I/O power VT_IO are given as illustrated in Table 6. Table 6 is an exemplary case in which the system I/O power System_IO supplied as the I/O power VT_IO is generated by a switching regulator having an efficiency of 90% in the PMIC 212.

TABLE 6

| | Operation | | | |
|---|---|---|---|---|
| | Power | Load-End | Battery | Input-End |
| Operation | Voltage | Consumption | Power | Consumption |
| Power | [V] | Current [mA] | Voltage [V] | Current [mA] |
| VT_Core | 1.5 | 100 | 3.8 | 43.85 |
| VT_Sensor | 2.8 | 30 | | 30 |
| VT_IO | 1.8 | 5 | | 2.63 |

| | |
|---|---|
| Sum | 76.48 |

As noted from (Table 6), although the input-end and load-end consumption currents of the sensor power VT_Sensor generated by the LDO 604 are equal, the input-end consumption currents 43.85 mA and 2.63 mA of the core power VT_Core and the I/O power VT_IO are less than their load-end consumption currents. The input-end consumption current of the core power VT_Core is calculated in the manner described with reference to Table 1 and the input-end consumption current of the I/O power VT_IO is calculated in the manner described with reference to Table 4.

A comparison between Table 2 and Table 6 reveals that the total input-end consumption current is remarkably reduced in this example from 135 mA to 76.48 mA.

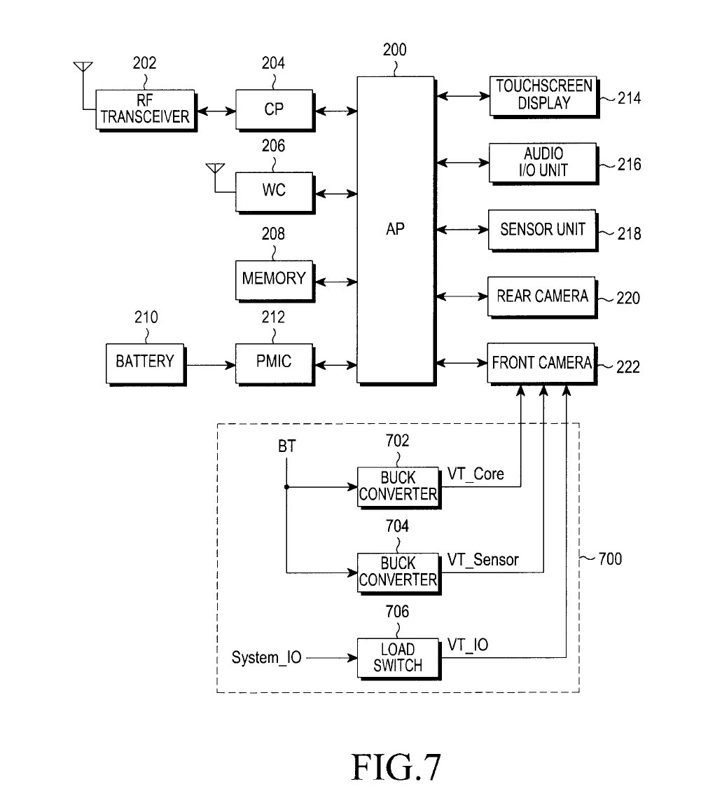

FIG. 7 is a block diagram of a mobile terminal according to a sixth exemplary embodiment of the present invention. The mobile terminal illustrated in FIG. 7 includes a power supply device 700 according to the sixth embodiment of the present invention. The mobile terminal illustrated in FIG. 7 is the same as that illustrated in FIG. 2 except for the power supply device 700 and thus a description of the other components will not be provided herein.

Referring now to FIG. 7, the power supply device 700 includes buck converters and 702 and 704, and a load switch 706. The buck converter 702 generates the core power VT_Core from the battery power BT and supplies the core power VT_Core to the front camera 222. The buck converter 704 generates the sensor power VT_Sensor from the battery power BT and supplies the sensor power VT_Sensor to the front camera 222. The load switch 706 supplies the system I/O power System_IO as the I/O power VT_IO to the front camera 222.

For example, assuming in this example that the voltages of the battery power BT, the core power VT_Core, the sensor power VT_Sensor, and the I/O power VT_IO are 3.8V, 1.5V, 2.8V, and 1.8V, respectively, the load-end consumption currents of the front camera 222, that is, the consumption currents of the core processor, the image sensor, and the I/O unit are 100 mA, 30 mA, and 5 mA, respectively, and the efficiency of the buck converters 702, 704 is 90%, input-end consumption currents, that is, input-end consumption currents of the core power VT_Core, the sensor power VT_Sensor, and the I/O power VT_IO are given as illustrated in Table 7 identical to Table 5. Table 7 is an exemplary case in which the system I/O power System_IO supplied as the I/O power VT_IO is generated by a switching regulator having an efficiency of 90% in the PMIC 212.

TABLE 7

| | Operation | | | |
|---|---|---|---|---|
| | Power | Load-End | Battery | Input-End |
| Operation | Voltage | Consumption | Power | Consumption |
| Power | [V] | Current [mA] | Voltage [V] | Current [mA] |
| VT_Core | 1.5 | 100 | 3.8 | 43.85 |
| VT_Sensor | 2.8 | 30 | | 24.56 |
| VT_IO | 1.8 | 5 | | 2.63 |

| | |
|---|---|
| Sum | 71.04 |

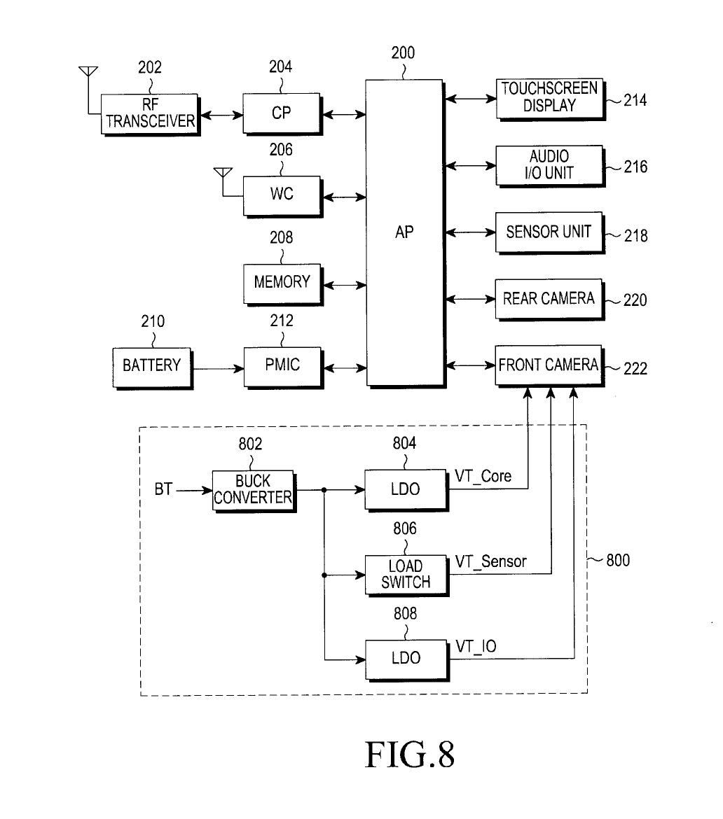

FIG. 8 is a block diagram of a mobile terminal according to a seventh exemplary embodiment of the present invention. The mobile terminal illustrated in FIG. 8 includes a power supply device 800 according to the seventh exemplary embodiment of the present invention. The mobile terminal illustrated in FIG. 8 is the same as that illustrated in FIG. 2 except for the power supply device 800 and thus a description of the other components will not be provided herein.

Referring now to FIG. 8, the power supply device 800 includes a buck converter 802, LDOs 804 and 808, and a load switch 806. The buck converter 802 generates a sub-power from the battery power BT. The LDO 804 generates the core power VT_Core from the sub-power generated from the buck converter 802 and supplies the core power VT_Core to the front camera 222. The load switch 806 supplies the sub-power generated from the buck converter 802 as the sensor power VT_Sensor to the front camera 222. The LDO 808 generates the I/O power VT_IO from the sub-power generated from the buck converter 802 and supplies the I/O power VT_IO to the front camera 222.

In this seventh exemplary embodiment of the present invention, the power supply device 800 is configured for the case in which the sensor power VT_Sensor has a higher voltage than each of the core power VT_Core and the I/O power VT_IO. Therefore, the buck converter 802 generates the sub-power having a voltage equal to that of the sensor power VT_Sensor and higher than that of each of the core power VT_Core and the I/O power VT_IO from the battery power BT.

For example, if the voltages of the battery power BT, the core power VT_Core, the sensor power VT_Sensor, and the I/O power VT_IO are respectively 3.8V, 1.5V, 2.8V, and 1.8V, in this example the buck converter 802 generates a sub-power with a voltage of 2.8V.

In this case, assuming that the load-end consumption currents of the front camera 222, more precisely, the consumption currents of the core processor, the image sensor, and the I/O unit are 100 mA, 30 mA, and 5 mA, respectively, and the efficiency of the buck converter 802 is 90%, input-end consumption currents, more precisely, input-end consumption currents of the core power VT_Core, the sensor power VT_Sensor, and the I/O power VT_IO are given as illustrated in Table 8.

TABLE 8

| | Sub- | Operation | Load-End | Battery | Input-End |
|---|---|---|---|---|---|
| | power | Voltage | Consumption | Power | Consumption |
| Operation | Voltage | Power | Current | Voltage | Current |
| Power | [V] | [V] | [mA] | [V] | [mA] |
| VT_Core | 2.8 | 1.5 | 100 | 3.8 | 81.87 |
| VT_Sensor | | 2.8 | 30 | | 24.56 |
| VT_IO | | 1.8 | 5 | | 4.09 |

| | |
|---|---|
| Sum | 110.52 |

As noted from Table 8, the input-end consumption currents 81.87 mA, 24.56 mA, and 4.09 mA of the core power VT_Core, the sensor power VT_Sensor, and the I/O power VT_IO are less than their load-end consumption currents. The input-end consumption currents of the core power VT_Core, the sensor power VT_Sensor, and the I/O power VT_IO are calculated by sub-power voltage×load-end consumption current/battery power BT voltage/90%.

A comparison between Table 2 and Table 8 reveals that the total input-end consumption current in this example is remarkably reduced from 135 mA to 110.52 mA.

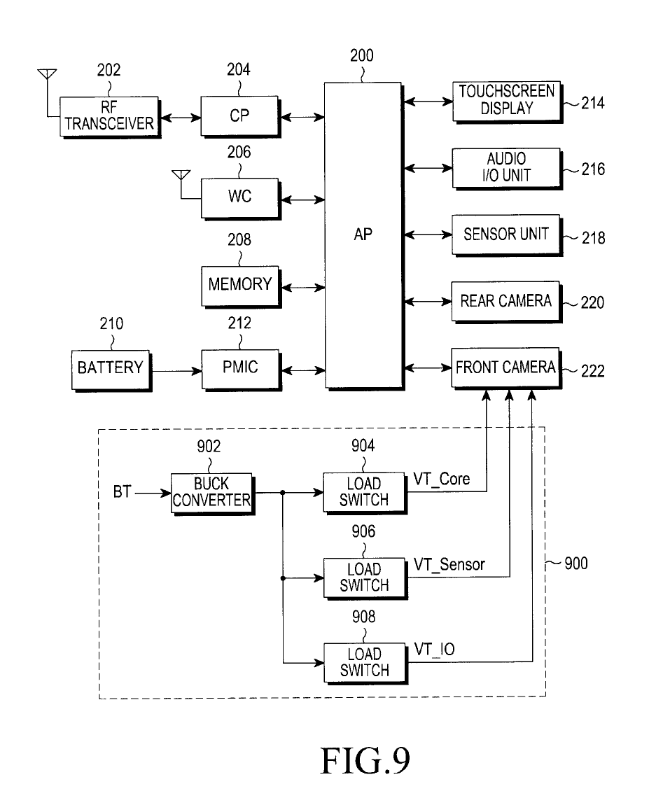

FIG. 9 is a block diagram of a mobile terminal according to an eighth exemplary embodiment of the present invention. The mobile terminal illustrated in FIG. 9 includes a power supply device 900 according to the eighth exemplary embodiment of the present invention. The mobile terminal illustrated in FIG. 9 is the same as that illustrated in FIG. 2 except for the power supply device 900 and thus a description of the other components will not be provided herein.

Referring now to FIG. 9, the power supply device 900 includes a buck converter 902 and load switches 904, 906 and 908. The buck converter 902 generates a sub-power from the battery power BT. The load switch 904 supplies the sub-power generated from the buck converter 902 as the core power VT_Core to the front camera 222. The load switch 906 supplies the sub-power generated from the buck converter 802 as the sensor power VT_Sensor to the front camera 222. The load switch 908 supplies the sub-power generated from the buck converter 902 as the I/O power VT_IO to the front camera 222.

In this exemplary embodiment of the present invention, the power supply device 900 is configured for the case in which the core power VT_Core, the sensor power VT_Sensor, and the I/O power VT_IO have the same voltage. Therefore, the buck converter 902 generates a sub-power having a voltage equal to those of the core power VT_Core, the sensor power VT_Sensor, and the I/O power VT_IO from the battery power BT.

For example, if the voltage of the battery power BT is 3.8V and the voltages of the core power VT_Core, the sensor power VT_Sensor, and the I/O power VT_IO are 1.8V, the buck converter 902 generates a sub-power with a voltage of 1.8V.

In this case, assuming that the load-end consumption currents of the front camera 222, in other words, the consumption currents of the core processor, the image sensor, and the I/O unit are 100 mA, 30 mA, and 5 mA, respectively, and the efficiency of the buck converter 902 is 90%, input-end consumption currents, meaning that the input-end consumption currents of the core power VT_Core, the sensor power VT_Sensor, and the I/O power VT_IO are given as illustrated in Table 9.

TABLE 9

| | Sub- | Operation | Load-End | Battery | Input-End |
|---|---|---|---|---|---|
| | power | Voltage | Consumption | Power | Consumption |
| Operation | Voltage | Power | Current | Voltage | Current |
| Power | [V] | [V] | [mA] | [V] | [mA] |
| VT_Core | 1.8 | 1.8 | 100 | 3.8 | 52.63 |
| VT_Sensor | | 1.8 | 30 | | 15.78 |
| VT_IO | | 1.8 | 5 | | 2.63 |

| | |
|---|---|
| Sum | 71.04 |

As noted from Table 9, the input-end consumption currents 52.63 mA, 15.78 mA and 2.63 mA of the core power VT_Core, the sensor power VT_Sensor, and the I/O power VT_IO are less than their load-end consumption currents. The input-end consumption currents of the core power VT_Core, the sensor power VT_Sensor, and the I/O power VT_IO are calculated by sub-power voltage×load-end consumption current/battery power BT voltage/90%.

A comparison between Table 2 and Table 9 reveals that the total input-end consumption current is remarkably reduced in this example from 135 mA to 71.04 mA.

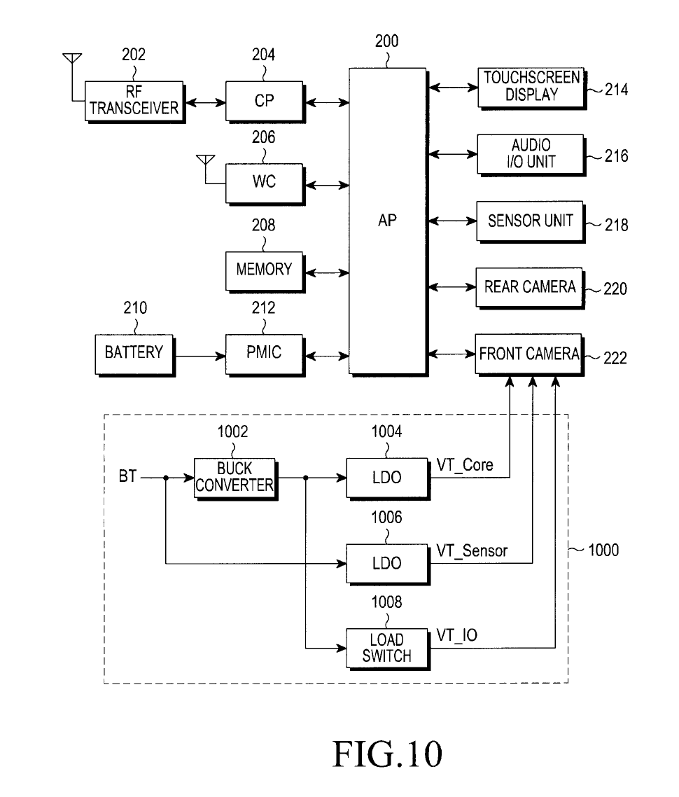

FIG. 10 is a block diagram of a mobile terminal according to a ninth exemplary embodiment of the present invention. The mobile terminal illustrated in FIG. 10 includes a power supply device 1000 according to the ninth exemplary embodiment of the present invention. The mobile terminal illustrated in FIG. 10 is the same as that illustrated in FIG. 2 except for the power supply device 1000 and thus a description of the other components will not be provided herein.

Referring now to FIG. 10, the power supply device 1000 includes a buck converter 1002, LDOs 1004 and 1006, and a load switch 1008. The buck converter 1002 generates a sub-power from the battery power BT. The LDO 1004 generates the core power VT_Core from the sub-power generated from the buck converter 902 and supplies the core power VT_Core to the front camera 222. The LDO 1006 generates the sensor power VT_Sensor from the battery power BT and supplies the sensor power VT_Sensor to the front camera 222. The load switch 1008 supplies the sub-power generated from the buck converter 1002 as the I/O power VT_IO to the front camera 222.

In this exemplary embodiment of the present invention, the power supply device 1000 is configured to generate a sub-power having a voltage equal to that of the I/O power VT_IO by the buck converter 1002 in the case where the voltage of the sensor power VT_Sensor is higher than that of each of the core power VT_Core and the I/O power VT_IO and the voltage of the I/O power VT_IO is higher than that of the core power VT_Core. Therefore, the buck converter 1002 generates a sub-power having a voltage higher than that of the core power VT_Core and equal to that of the I/O power VT_IO from the battery power BT.

For example, if the voltages of the battery power BT, the core power VT_Core, the sensor power VT_Sensor, and the I/O power VT_IO are respectively 3.8V, 1.5V, 2.8V, and 1.8V, the buck converter 1002 generates a sub-power with a voltage of 1.8V.

In this case, assuming that the load-end consumption currents of the front camera 222, more precisely, the consumption currents of the core processor, the image sensor, and the I/O unit are 100 mA, 30 mA, and 5 mA, respectively, and the efficiency of the buck converter 1002 is 90%, input-end consumption currents, in other words, the input-end consumption currents of the core power VT_Core, the sensor power VT_Sensor, and the I/O power VT_IO are given as illustrated in Table 10.

TABLE 10

| | Sub- | Operation | Load-End | Battery | Input-End |
|---|---|---|---|---|---|
| | power | Power | Consumption | Power | Consumption |
| Operation | Voltage | Voltage | Current | Voltage | Current |
| Power | [V] | [V] | [mA] | [V] | [mA] |
| VT_Core | 1.8 | 1.5 | 100 | 3.8 | 52.63 |
| VT_Sensor | — | 2.8 | 30 | | 30 |
| VT_IO | 1.8 | 1.8 | 5 | | 2.63 |

| | |
|---|---|
| Sum | 85.26 |

As noted from Table 10, although the input-end and load-end consumption currents of the sensor power VT_Sensor generated by the LDO 1006 are equal, the input-end consumption currents 52.63 mA and 2.63 mA of the core power VT_Core and the I/O power VT_IO are less than their load-end consumption currents. The input-end consumption currents of the core power VT_Core and the I/O power VT_IO are calculated in the manner described with reference to Table 9.

A comparison between Table 2 and Table 10 reveals that the total input-end consumption current is remarkably reduced from 135 mA to 85.26 mA.

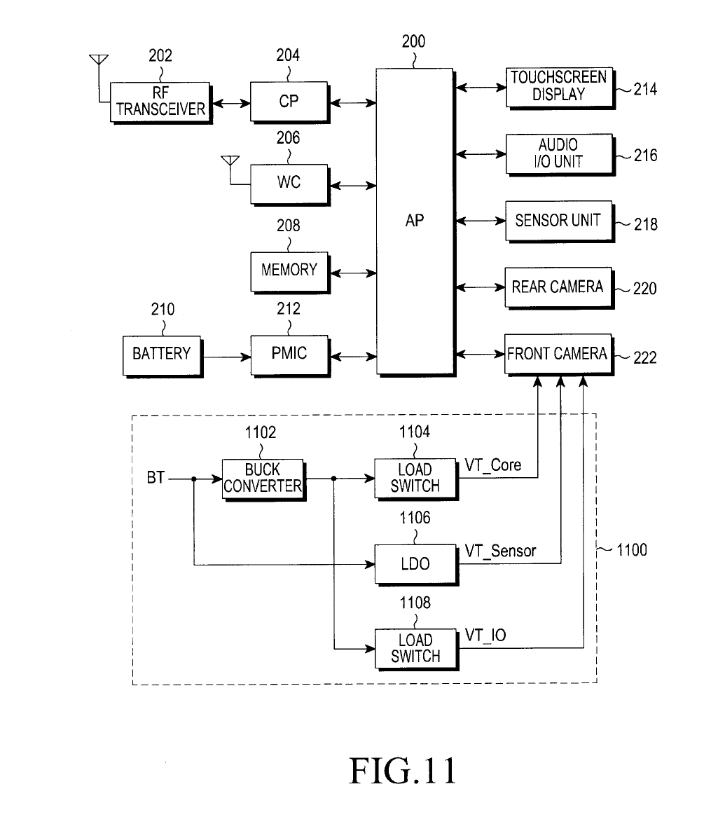

FIG. 11 is a block diagram of a mobile terminal according to a tenth exemplary embodiment of the present invention. The mobile terminal illustrated in FIG. 11 includes a power supply device 1100 according to the tenth exemplary embodiment. The mobile terminal illustrated in FIG. 11 is the same as that illustrated in FIG. 2 except for the power supply device 1100 and thus a description of the other components will not be provided herein.

Referring now to FIG. 11, the power supply device 1100 includes a buck converter 1102, load switches 1104 and 1108, and an LDO 1106. The buck converter 1102 generates a sub-power from the battery power BT. The load switch 1104 supplies the sub-power generated from the buck converter 902 as the core power VT_Core to the front camera 222. The LDO 1106 generates the sensor power VT_Sensor from the battery power BT and supplies the sensor power VT_Sensor to the front camera 222. The load switch 1108 supplies the sub-power generated from the buck converter 1102 as the I/O power VT_IO to the front camera 222.

In this exemplary embodiment of the present invention, the power supply device 1100 is configured to generate a sub-power having a voltage equal to those of the core power VT_Core and the I/O power VT_IO by the buck converter 1102 in the case where the voltage of the sensor power VT_Sensor is higher than that of each of the core power VT_Core and the I/O power VT_IO and the voltage of the I/O power VT_IO is equal to that of the core power VT_Core. Therefore, the buck converter 1102 generates a sub-power having a voltage equal to those of the core power VT_Core and the I/O power VT_IO from the battery power BT.

For example, if the voltages of the battery power BT, the core power VT_Core, the sensor power VT_Sensor, and the I/O power VT_IO are respectively 3.8V, 1.8V, 2.8V, and 1.8V, the buck converter 1102 generates a sub-power with a voltage of 1.8V.

In this case, assuming that the load-end consumption currents of the front camera 222, more precisely, the consumption currents of the core processor, the image sensor, and the I/O unit are 100 mA, 30 mA, and 5 mA, respectively, and the efficiency of the buck converter 1102 is 90%, input-end consumption currents, that is, input-end consumption currents of the core power VT_Core, the sensor power VT_Sensor, and the I/O power VT_IO are given as illustrated in Table 11 identical to Table 10.

TABLE 11

| | Sub- | Operation | Load-End | Battery | Input-End |
|---|---|---|---|---|---|
| | power | Power | Consumption | Power | Consumption |
| Operation | Voltage | Voltage | Current | Voltage | Current |
| Power | [V] | [V] | [mA] | [V] | [mA] |
| VT_Core | 1.8 | 1.5 | 100 | 3.8 | 52.63 |
| VT_Sensor | — | 2.8 | 30 | | 30 |
| VT_IO | 1.8 | 1.8 | 5 | | 2.63 |

| | |
|---|---|
| Sum | 85.26 |

As noted from Table 11, although the input-end and load-end consumption currents of the sensor power VT_Sensor generated by the LDO 1106 are equal, the input-end consumption currents 52.63 mA and 2.63 mA of the core power VT_Core and the I/O power VT_IO are less than their load-end consumption currents. The input-end consumption currents of the core power VT_Core and the I/O power VT_IO are calculated in the manner described with reference to Table 9.

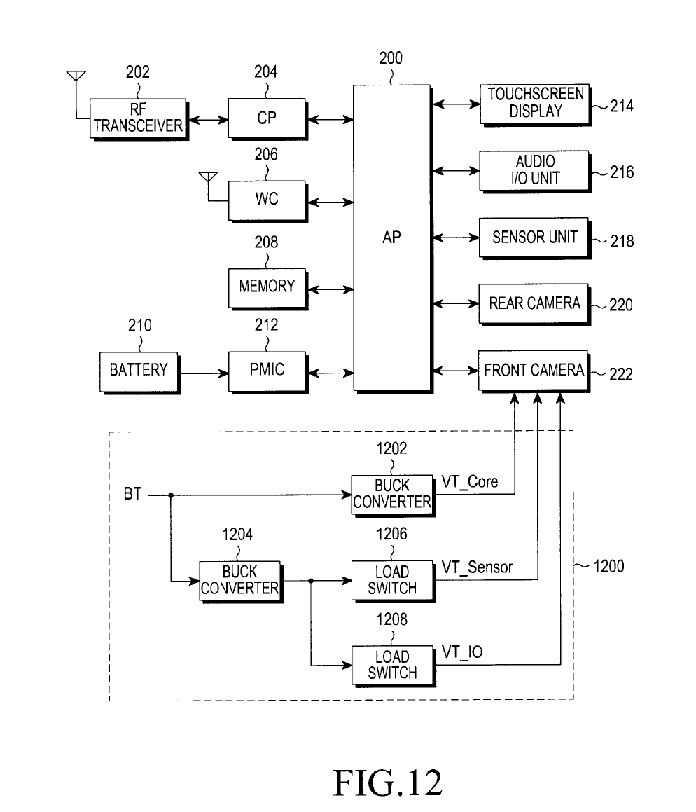

FIG. 12 is a block diagram of a mobile terminal according to an eleventh exemplary embodiment of the present invention. The mobile terminal illustrated in FIG. 12 includes a power supply device 1200 according to the eleventh exemplary embodiment of the present invention. The mobile terminal illustrated in FIG. 12 is the same as that illustrated in FIG. 2 except for the power supply device 1200 and thus a description of the other components will not be provided herein.

Referring now to FIG. 12, the power supply device 1200 in this example includes buck converters 1202 and 1204 and load switches 1206 and 1208. The buck converter 1202 generates the core power VT_Core from the battery power BT and supplies the core power VT_Core to the front camera 222. The buck converter 1204 generates a sub-power from the battery power BT. The load switch 1206 supplies the sub-power generated from the buck converter 1204 as the sensor power VT_Sensor to the front camera 222. The load switch 1208 supplies the sub-power generated from the buck converter 1204 as the I/O power VT_IO to the front camera 222.

In this exemplary embodiment of the present invention, the power supply device 1200 is configured to generate a sub-power having a voltage equal to those of the sensor power VT_Sensor and the I/O power VT_IO by the buck converter 1204 in the case where the voltage of the sensor power VT_Sensor is equal to that of the I/O power VT_IO. Therefore, the buck converter 1204 generates a sub-power having a voltage equal to those of the sensor power VT_Sensor and the I/O power VT_IO from the battery power BT.

For example, if the voltages of the battery power BT, the core power VT_Core, the sensor power VT_Sensor, and the I/O power VT_IO are respectively 3.8V, 1.5V, 1.8V, and 1.8V, the buck converter 1204 generates a sub-power with a voltage of 1.8V.

In this case, assuming that the load-end consumption currents of the front camera 222, in other words, the consumption currents of the core processor, the image sensor, and the I/O unit are 100 mA, 30 mA, and 5 mA, respectively, and the efficiency of the buck converters 1202 and 1204 is 90%, input-end consumption currents, more precisely, the input-end consumption currents of the core power VT_Core, the sensor power VT_Sensor, and the I/O power VT_IO are given as illustrated in Table 12.

TABLE 12

| | Sub- | Operation | Load-End | Battery | Input-End |
|---|---|---|---|---|---|
| | power | Power | Consumption | Power | Consumption |
| Operation | Voltage | Voltage | Current | Voltage | Current |
| Power | [V] | [V] | [mA] | [V] | [mA] |
| VT_Core | — | 1.5 | 100 | 3.8 | 43.85 |
| VT_Sensor | 1.8 | 1.8 | 30 | | 15.78 |
| VT_IO | | 1.8 | 5 | | 2.63 |

| | |
|---|---|
| Sum | 62.26 |

As noted from Table 12, the input-end consumption currents 43.85 mA, 15.78 mA and 2.63 mA of the core power VT_Core, the sensor power VT_Sensor, and the I/O power VT_IO are less than their load-end consumption currents. It will be understood to those skilled in the art that the input-end consumption currents of the core power VT_Core, the sensor power VT_Sensor, and the I/O power VT_IO are calculated in the manners described before.

A comparison between Table 2 and Table 12 reveals that the total input-end consumption current is remarkably reduced from 135 mA to 62.26 mA, a value less than half of the load-end consumption currents.

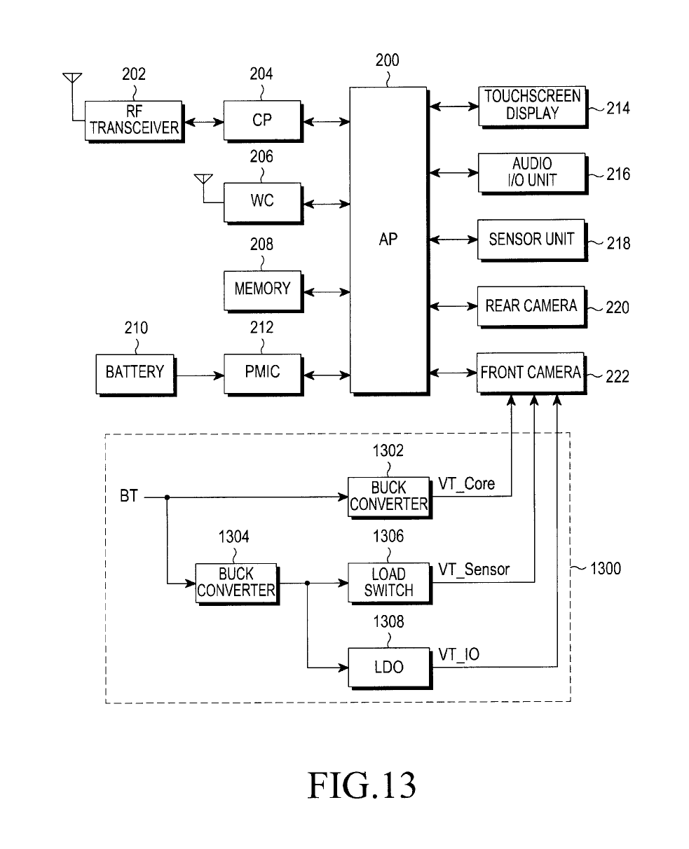

FIG. 13 is a block diagram of a mobile terminal according to a twelfth exemplary embodiment of the present invention. The mobile terminal illustrated in FIG. 13 includes a power supply device 1300 according to the twelfth exemplary embodiment of the present invention. The mobile terminal illustrated in FIG. 13 is the same as that illustrated in FIG. 2 except for the power supply device 1300 and thus a description of the other components will not be provided herein.

Referring now to FIG. 13, the power supply device 1300 includes buck converters 1302 and 1304, a load switch 1306, and an LDO 1308. The buck converter generates the core power VT_Core from the battery power BT and supplies the core power VT_Core to the front camera 222. The buck converter 1304 generates a sub-power from the battery power BT. The load switch 1306 supplies the sub-power generated from the buck converter 1304 as the sensor power VT_Sensor to the front camera 222. The LDO 1308 generates the I/O power VT_IO from the sub-power generated from the buck converter 1304 and supplies the I/O power VT_IO to the front camera 222.

In this exemplary embodiment of the present invention, the power supply device 1300 is configured for the case where the voltage of the sensor power VT_Sensor is higher than that of the I/O power VT_IO and a sub-power having a voltage equal to that of the sensor power VT_Sensor is generated by the buck converter 1304. Therefore, the buck converter 1304 generates a sub-power having a voltage equal to that of the sensor power VT_Sensor from the battery power BT.

For example, if the voltages of the battery power BT, the core power VT_Core, the sensor power VT_Sensor, and the I/O power VT_IO are respectively 3.8V, 1.5V, 2.8V, and 1.8V, the buck converter 1304 generates a sub-power with a voltage of 2.8V.

In this case, assuming that the load-end consumption currents of the front camera 222, more precisely, the consumption currents of the core processor, the image sensor, and the I/O unit are 100 mA, 30 mA, and 5 mA, respectively, and the efficiency of the buck converters 1302 and 1304 is 90%, input-end consumption currents, that is, input-end consumption currents of the core power VT_Core, the sensor power VT_Sensor, and the I/O power VT_IO are given as illustrated in Table 13.

TABLE 13

| | Sub- | Operation | Load-End | Battery | Input-End |
|---|---|---|---|---|---|
| | power | Power | Consumption | Power | Consumption |
| Operation | Voltage | Voltage | Current | Voltage | Current |
| Power | [V] | [V] | [mA] | [V] | [mA] |
| VT_Core | — | 1.5 | 100 | 3.8 | 43.85 |
| VT_Sensor | 1.8 | 2.8 | 30 | | 24.56 |
| VT_IO | | 1.8 | 5 | | 2.63 |

| | |
|---|---|
| Sum | 72.50 |

As noted from Table 13, the input-end consumption currents 43.85 mA, 24.56 mA and 2.63 mA of the core power VT_Core, the sensor power VT_Sensor, and the I/O power VT_IO are less than their load-end consumption currents. It will be understood to those skilled in the art that the input-end consumption currents of the core power VT_Core, the sensor power VT_Sensor, and the I/O power VT_IO are calculated in the manners described before.

A comparison between Table 2 and Table 13 reveals that the total input-end consumption current is remarkably reduced from 135 mA to 72.50 mA.

The power supply device for a camera device may be configured in various manners according to one of the aforementioned exemplary embodiments of the present invention or the configuration corresponding to the embodiment of the present invention, taking into account the voltages and power consumptions of the core power VT_Core, the sensor power VT_Sensor, and the I/O power VT_IO, and the space in the mobile terminal. Therefore, an optimized power supply device for a camera device may be configured in a mobile terminal, taking into account the voltages and power consumptions of the core power VT_Core, the sensor power VT_Sensor, and the I/O power VT_IO, and the space in the mobile terminal.

Therefore, according to the embodiments of the present invention, the consumption current of the power supply device for the camera device can be reduced by generating at least a part of the operating powers of the camera device using a switching regulator in the mobile terminal. Therefore, the power device for the camera device can be optimized.

A camera device such as the front camera 222 may have a unique power sequence. The power sequence defines a specific supply timing for each of the core power VT_Core, the sensor power VT_Sensor, and the I/O power VT_IO.

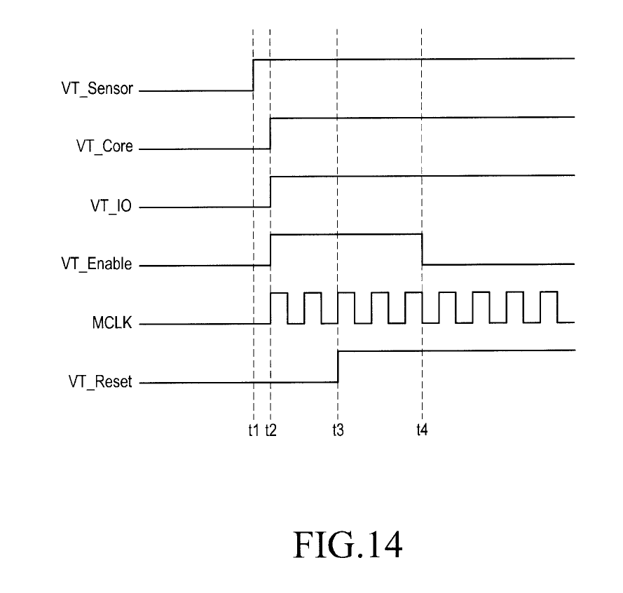

FIG. 14 is an exemplary diagram of a power sequence for the front camera. The power sequence is a typical example. The AP 200 may control the power sequence illustrated in FIG. 14. The AP 200 selectively switches supply of each of the core power VT_Core, the sensor power VT_Sensor, and the I/O power VT_IO to the front camera 222 by controlling a buck converter, an LDO, and a load switch through control of an enable port of the buck converter, an enable port of the LDO, and a switching control port of the load switch according to the power sequence.

Still referring to FIG. 14, after the core power VT_Core is supplied at time t1, for example, the sensor power VT_Sensor and the I/O Power VT_IO should be supplied within 1 ms from time t1.

A front camera enable signal VT_Enable should be activated at least 20 μs after time t2 when all of the core power VT_Core, the sensor power VT_Sensor, and the I/O power VT_IO start to be supplied. The front camera enable signal VT_Enable is used to enable the front camera. In addition, a main clock signal MCLK should be supplied at least 0 μs after time t2 when all of the core power VT_Core, the sensor power VT_Sensor, and the I/O power VT_IO start to be supplied. The main clock signal MCLK is a clock signal for operating the front camera. A front camera reset signal VT_Reset should be activated at least 4 ms after time t2. The front camera enable signal VT_Enable should be deactivated at least 4 ms after time t3 when the front camera reset signal VT_Reset is activated.

After the front camera is initialized according to the activation of the front camera reset signal VT_Reset, the front camera starts to transmit data captured by the image sensor to the AP.

While the specific exemplary embodiments of the present invention have been described above, many modifications can be made to them within the scope of the present invention.

For example, if a product is used as the front camera 222, to which no problem occurs despite no control of the supply timings of the core power VT_Core, the sensor power VT_Sensor, and the I/O power VT_IO according to the power sequence as illustrated in FIG. 4, there is no need for controlling the supply timings of the core power VT_Core, the sensor power VT_Sensor, and the I/O power VT_IO. In this particular case, the load switches 606, 706, 806, 904, 906, 1008, 1104, 1108, 1206, 1208, and 1306 illustrated in FIGS. 6 to 13 are not needed. In other words, the load switches 606, 706, 806, 904, 906, 1008, 1104, 1108, 1206, 1208, and 1306 may be replaced with conductors.

While a buck converter is used as an example of switching regulator when the voltages of the core power VT_Core, the sensor power VT_Sensor, and the I/O power VT_IO are lower than that of the battery power BT in the exemplary embodiments of the present invention, a boost converter may be used instead, when the camera device requires a power voltage higher than the voltage of the battery power BT. Also, while the preferred described device is a front camera, other devices, modules, or units requiring a plurality of operating powers form a power supply are also within the scope of the receiving power from the power supply device according to the presently claimed invention.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

In addition, an artisan understands and appreciates that a “processor” or “microprocessor” constitute hardware in the claimed invention. Under the broadest reasonable interpretation, the appended claims constitute statutory subject matter in compliance with 35 U.S.C. §101. The terms “unit” or “module” if referred to herein is to be understood as constituting hardware such as a processor or microprocessor configured for a certain desired functionality in accordance with statutory subject matter under 35 U.S.C. §101 and does not constitute software per se.

While the present invention has been particularly shown and described with reference to embodiments thereof, it will be understood by those of ordinary skill in the art that various changes in form and details may be made therein without departing from the spirit and scope of the present invention as defined by the following claims.

What is claimed is:

1. A power supply device for a device operating at a plurality of operating powers in a mobile terminal, comprising:
a switching regulator that generates from an input power received by mobile terminal an operating power for a particular component having a highest power consumption among the operating powers of the device.

2. The power supply device of claim 1, wherein the switching regulator comprises a first switching regulator that generates a core power for a core processor from among the plurality of operating powers, and wherein the input power comprises battery power received by the mobile terminal.

3. The power supply device of claim 2, further comprising a second switching regulator for generating a sensor power for a sensor from among the plurality of operating powers from the battery power.

4. The power supply device of claim 3, further comprising a third switching regulator for generating an Input/Output (I/O) power from among the plurality of operating powers from the battery power.

5. The power supply device of claim 3, wherein one of the plurality of regulators comprises a Low DropOut (LDO) for generating an I/O power from among the plurality of operating powers from the battery power.

6. The power supply device of claim 3, further comprising a load switch for supplying a system I/O power of the mobile terminal as an I/O power from among the plurality of operating powers.

7. The power supply device of claim 2, wherein one of the plurality of regulators comprises a Low DropOut (LDO) for generating a sensor power from among the plurality of operating powers from the battery power.

8. The power supply device of claim 7, further comprising a second switching regulator for generating an I/O power from among the plurality of operating powers from the battery power.

9. The power supply device of claim 7, further comprising another LDO for generating an I/O power from among the plurality operating powers from the battery power.

10. The power supply device of claim 7, further comprising a load switch for supplying a system I/O power of the mobile terminal as an I/O power from among the plurality of operating powers.

11. The power supply device of claim 2, wherein the device comprises a camera of the mobile terminal.

12. The power supply device of claim 11, wherein the camera comprises a front camera of the mobile terminal.

13. A power supply device for a camera device of a mobile terminal operating at a plurality of different operating powers in a mobile terminal, the power supply device comprising:
a switching regulator for generating a sub-power from a battery power of the mobile terminal;
a first Low DropOut (LDO) regulator for generating a core power for a core processor from among the plurality of different operating powers from the sub-power of the battery power; and
a second LDO for generating an Input/Output (I/O) power from among the plurality of different operating powers from the sub-power,
wherein the sub-power is supplied as a sensor power from among the plurality of different operating powers.

14. The power supply device of claim 13, further comprising a load switch electrically arranged between the sub-power and the sensor power.

15. The power supply device of claim 13, wherein the camera device comprises is a front camera.

16. A power supply device for a camera device in a mobile terminal that includes components operating at a plurality of operating powers, the power supply device comprising:
at least one switching regulator for generating a sub-power from a battery power of the mobile terminal,
wherein the sub-power is supplied as a core power, a sensor power, and an Input/Output (I/O) power from among the plurality of operating powers of the camera device.

17. The power supply device of claim 16, further comprising:
a first load switch electrically arranged between the sub-power and the core power;
a second load switch electrically arranged between the sub-power and the sensor power; and
a third load switch electrically arranged between the sub-power and the I/O power.

18. The power supply device of claim 16, wherein the camera device comprises a front camera of the mobile terminal.

19. A power supply device for a camera device operating at a plurality of operating powers in a mobile terminal, comprising:
a switching regulator for generating a sub-power from a battery power of the mobile terminal;
a first Load DropOut (LDO) for generating a core power among the operating powers from the sub-power; and
a second LDO for generating a sensor power among the operating powers from the battery power,
wherein the sub-power is supplied as an Input/Output (I/O) power from among the plurality of operating powers.

20. The power supply device of claim 19, further comprising a load switch electrically arranged between the sub-power and the I/O power.

21. A power supply device for a camera device operating at a plurality of different operating powers in a mobile terminal, comprising:
a switching regulator for generating a sub-power from a battery power of the mobile terminal; and
a Load DropOut (LDO) for generating a sensor power from among the plurality of different operating powers from the battery power,
wherein the sub-power is supplied as a core power and an Input/Output (I/O) power from among the plurality of operating powers.

22. The power supply device of claim 21, further comprising:
a load switch electrically arranged between the sub-power and the core power; and
a load switch electrically arranged between the sub-power and the I/O power.

23. A power supply device for a camera device operating at a plurality of operating powers in a mobile terminal, comprising:
a switching regulator for generating from a power source received by the mobile terminal a core power from among the plurality of operating powers; and
a switching regulator for generating a sub-power from the power source,
wherein the sub-power is supplied as a sensor power and an Input/Output (I/O) power from among the plurality of operating powers.

24. The power supply device of claim 23, further comprising:
a load switch electrically arranged between the sub-power and the sensor power; and
a load switch electrically arranged between the sub-power and the I/O power.

25. A power supply device for a camera device operating at a plurality of operating powers in a mobile terminal, comprising:
a switching regulator for generating a core power among the operating powers from a battery power of the mobile terminal;
a switching regulator for generating a sub-power from the battery power; and
a Low DropOut (LDO) for generating an Input/Output (I/O) power among the operating powers from the sub-power,
wherein the sub-power is supplied as a sensor power among the operating powers.

26. The power supply device of claim 25, further comprising a load switch electrically arranged between the sub-power and the sensor power.
